(19) United States
(12) Patent Application Publication
(10) Pub. No.: US 2003/0009445 A1
(43) Pub. Date: Jan. 9, 2003

(54) Internet database sevice 'IDS'

(76) Inventor: Santhanagopalan Muthukannan, Fremont, CA (US)

Correspondence Address: SANTHANAGOPALAN MUTHUKANNAN, 184 BEAR COURT, FREMONT, CA, 94539, US

(21) Appl. No.: 10/192,210

(22) Filed: Jul. 9, 2002

Related U.S. Application Data
(60) Provisional application No. 60/303,993, filed on Jul. 9, 2001.

(51) Int. Cl. G06F 17/30

(52) U.S. Cl. 707/1; 700/10

(57) ABSTRACT

The rapid expansion of Internet technology and global business environment has set demands for newer and faster software applications enabling B2B commerce and information exchange. This invention provides an Internet database access framework with complete client interfaces, a rich set of back office components and a powerful middle tier transaction platform to make databases accessible around the world. This framework allows data storage or access as a service within minutes of request, eliminating long waiting time and unnecessary expenses. The framework is light and portable and is based on thin client and thin server model. It is a unique solution that offers high performance and scalability with a rich set of extendible features. The IDS framework presents a clear solution to present day's database access and availability constraints.

### CROSS-REFERENCE TO RELATED APPLICATIONS

I claim the benefit of an earlier U.S. provisional patent application No. 60/303,993 with title ‘Internet Database Service ‘IDS’’ dated Jul. 9, 2001.

### STATEMENT REGARDING FEDERALLY SPONSORED RESEARCH OR DEVELOPMENT

Not Applicable

### BACKGROUND OF THE INVENTION

The invention relates to the field of database and in particular to the access, deployment, data management and real time sharing of information at a global level.

The rapid expansion of Internet technology and global business environment has set demands for newer and faster software applications to enable B2B commerce and information exchange for the coming years. In today's information age, access to information at all times is critical. Organizations are spread out at various locations and have a need to access and share information. This requires a single database to house information or several databases to be integrated and managed. This is further complicated when the organizations are spread globally and have to share information with outside parties such as suppliers, customers and partners.

Further, the present database environment does not meet the current needs, not to mention scaling to meet future needs of the marketplace. Conventional databases are primarily deployed in Wide Area Network (WAN) of an organization for a specific purpose and often times are not sharable. This creates a major hurdle for programmers developing applications, which need access to a database, to store and manipulate data. Often times, this scenario calls for fresh installation, which requires domain experts from various fields including security, networking and database itself. This process is time consuming; eating away at precious “time to market” which increases real and hidden costs and results in lost revenues and lower profits.

Most databases are platform dependent, prohibiting the customer from adopting newer and better hardware and infrastructure. The integration of databases with software modules involves additional levels of expenses since one change often requires a unilateral change. The financial implications of repeated user training and unfamiliarity with new software, negatively impacts businesses and eats into an already eroded margin.

Today's applications often have to be modified to be Internet ready for access from outside of an enterprise, creating a huge barrier in the availability of information. Most of the applications are bulky, wrap around, non-user friendly, platform specific and require mega servers to house and deploy. These issues have created a barrier for the Service Providers to host applications on the Internet as the cost of infrastructure has become exorbitant.

In short, today's database applications are complicated to deploy, access and maintain. They are expensive and do not scale. The total cost of ownership (TCO) is very high and is not consistent with the associated benefits.

### BRIEF SUMMARY OF THE INVENTION

This invention, Internet Database Service (IDS) framework provides a clear process, by which databases could be made more affordable and available. The IDS framework proposes a client server based software solution that manages databases at the Service Provider (SP) or enterprise level so that users could have access to databases within minutes.

This invention provides a solution to the deficiencies existing in the database availability model. Further, IDS provides clear economic advantages to the end user by saving significant amount of time, material and resources in areas including database implementation, integration and usage.

All of the above is achieved in a code size less than a Mega byte making it an extremely light and portable software. This invention also allows the service providers to flourish by offering highly scalable and available solutions at a fraction of the cost of the major players. The possibility of making database available to anyone in minutes instead of days or weeks opens the doors for newer types of services to be offered on the Web. This enables service providers and enterprises to offer newer and faster applications that are current.

Advantages

1) Low Application Development Cost

IDS framework allows databases to be leased during application development eliminating the cost of ownership.

2) Light and Portable

IDS framework solution is extremely small in size allowing it to be portable and easily deployable, eliminating large hardware costs.

3) Platform Independent Applications

IDS framework solution has been developed in Java to work on all Java enabled operating systems. This allows the organizations to develop applications to be platform independent and conform to open standards.

4) Rapid Development, Test and Launch

IDS framework allows applications be developed, tested and launched in a short span of time. Developers can test their software with the databases from anywhere in the world and launch the software in a rapid manner.

5) Flexible, Manageable and Extendible

The client side of the IDS framework solution is a flexible solution that allows clients to extend its functionality. IDS framework allows clients to access and manage databases located anywhere.

6) Rapid Integration

IDS framework solution allows an easy and smooth integration with existing software systems.

7) Security, Performance, and Reliability

IDS framework provides a secure transaction medium utilizing the latest security standards. The small size code and robust framework provides high performance capability in all tiers and a reliable system.

8) Flexible Deployment Options

Applications developed using IDS framework have several deployment options saving organizations significant money and resources.

9) Cut Maintenance Costs

IDS framework solution does not require heavy infrastructure in terms of networking and computing hardware. The flexible deployment options and highly automated features of the solution provide significant cost savings in maintenance.

### BRIEF DESCRIPTION OF THE SEVERAL VIEWS OF THE DRAWING

Not Applicable

### DETAILED DESCRIPTION OF THE INVENTION

This invention, Internet Database Service (IDS) framework provides a clear process, by which databases could be made more affordable and available. The IDS framework proposes a client server based software solution that manages databases at the Service Provider (SP) or at the enterprise level so that users could have access to databases within minutes.

The IDS server basically manages the databases at the backend allowing the administrator to manage access to databases from organizations, departments and users at any instance and allocating the required connections and storage spaces in the appropriate servers. Once this process is complete, the end users are allowed to access the database of their choice immediately either via the client user interfaces offered by the IDS or programmatically.

The Graphical user interface APIs of the IDS framework offers a rich set of features for the developers to quickly customize or extend its functionality. Its powerful middleware and networking components allows seamless connections between client and server modules. The IDS with its distributed computing model, allows it to connect with databases spread across the world. These features allow the developers to reuse the IDS framework for various types of software modules without having to integrate additional middleware and server components and mix and match databases.

The IDS framework provides several key components that are necessary for an enterprise or Internet software application. The components include middleware, network, security, user management and communication. It offers a high level of security with features such as digital signatures, encryption of data, access control and database authentication.

The robust framework provides tight integration and at the same time offers the total flexibility to extend its rich functionality. By providing the components as reusable objects the platform allows applications to use them multiple times, without redundant coding, by invoking the components. This also minimizes the necessity of integrating with third party components saving significant amount of money and resources.

This framework revolutionizes the way in which databases are made available at a global level as a service. This provides a unique opportunity for software developers, resellers and integrators to jump-start their development efforts saving significant amount of time and resources.

The IDS framework has been developed in Java to work on all Java enabled operating systems. The use of the framework allows organizations to develop applications that are platform independent and conform to open standards. Although, the solution has been developed using Java as the base computer language as a product, the process is programming language independent.

The framework allows the IDS servers to be hosted both in the Enterprise and Service Provider (SP) environment. With its lightweight characteristics, the framework provides an opportunity for organizations to host several of their IDS server software in a single hardware server. This by itself is a significant shift from the present day paradigm of having several hardware servers to host a single software application, creating a positive economic impact.

The IDS servers and client interfaces are extremely thin and portable with a size of less than one Mega byte. This invention also allows the software development companies and service providers to flourish by offering highly scalable and available database access solutions at a fraction of the cost of the major players. The possibility of software development in weeks instead of months opens the doors for newer types of services to be offered on the Web.

This invention provides a solution to the deficiencies existing in the database market. Further, the platform provides clear economic advantages to the end user by saving significant amount of time, material and resources in areas including software development, implementation, integration and usage.

What I claim is:

1. A database service framework that allows users to setup and access databases within minutes.

2. An extendible Internet Database Service framework that allows the management of databases and data storage servers worldwide to manipulate and manage data in real time.

3. A service process that provides access to databases and data storage as a web service.
